(19) United States
(12) Patent Application Publication
(10) Pub. No.: US 2005/0116062 A1
(43) Pub. Date: Jun. 2, 2005

(54) Shower device having adjustable mechanism

(76) Inventor: Tsai Chen Yang, Taichung (TW)

Correspondence Address: Tsai Chen YANG, P.O. Box 63-99, Taichung, 406, TW

(21) Appl. No.: 10/725,323

(22) Filed: Nov. 28, 2003

(51) Int. Cl. B05B 15/06

(52) U.S. Cl. 239/283; 239/282

(57) ABSTRACT

A shower device includes a conduit having a bore to slidably receive a lower portion of a tube, and to allow the tube to be adjusted up and down relative to the conduit. A shower head is attached to the tube and moved up and down together with the tube, and a control ferrule is attached to the conduit and the tube, and includes two or more sealing rings to make water tight seals between the conduit and the control ferrule, and between the tube and the control ferrule. The tube may be secured to a supporting surface with a bracket.

### BACKGROUND OF THE INVENTION

1. Field of the Invention

The present invention relates to a shower device, and more particularly to a shower device including an adjustable structure or configuration to allow the shower head to be easily adjusted up and down relative to the supporting walls or relative to the users.

2. Description of the Prior Art

Various kinds of typical shower devices have been developed and widely used, and comprise a shower head to be secured to a supporting wall with a support or fastener member, and to be directed toward the users, to shower the users.

For example, French Patent No. 1,109,492 to Sinclair and U.S. Pat. No. 2,216,149 to Weiss disclose two of the typical shower devices each having a shower head adjustably secured to the supporting wall with a sucker member, and to allow the shower head to be adjusted up and down relative to the users.

However, the sucker members have to support the whole weight of the shower head and the hoses coupling to the shower head, and the sucker members may thus be easily slip or moved relative to the supporting wall, such that the shower head may have a good chance to move or slip downwardly relative to the supporting wall.

In addition, while showering, the water flowing out of the shower head may further provide a force against the shower head and thus against the sucker members, and may further move the sucker members relative to the supporting wall.

The present invention has arisen to mitigate and/or obviate the afore-described disadvantages of the conventional devices to support the shower heads.

### SUMMARY OF THE INVENTION

The primary objective of the present invention is to provide a shower device including an adjustable structure or configuration to allow the shower head to be easily adjusted up and down relative to the supporting walls or relative to the users.

In accordance with one aspect of the invention, there is provided a shower device comprising a conduit including a bore formed therein, a tube including a lower portion slidably engaged into the bore of the conduit, to allow the tube to be adjusted up and down relative to the conduit, a shower head attached to the tube and moved up and down together with the tube, a control ferrule attached to the conduit and the tube, and including at least one first sealing ring engaged between the conduit and the control ferrule, to make a water tight seal between the conduit and the control ferrule, and including at least one second sealing ring engaged between the tube and the control ferrule, to make a water tight seal between the tube and the control ferrule, and an attaching device for attaching the tube to a supporting surface.

The conduit includes an outer thread formed thereon, the control ferrule includes an inner thread formed therein to thread with the outer thread of the conduit. The attaching device includes a bracket secured to the supporting surface, and having a ring to support the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a shower device in accordance with the present invention;

FIG. 2 is an enlarged partial cross sectional view of the shower device; and

FIG. 3 is a cross sectional view of a control ferrule of the shower device.

### DETAILED DESCRIPTION OF THE PREFERRED EMBODIMENT

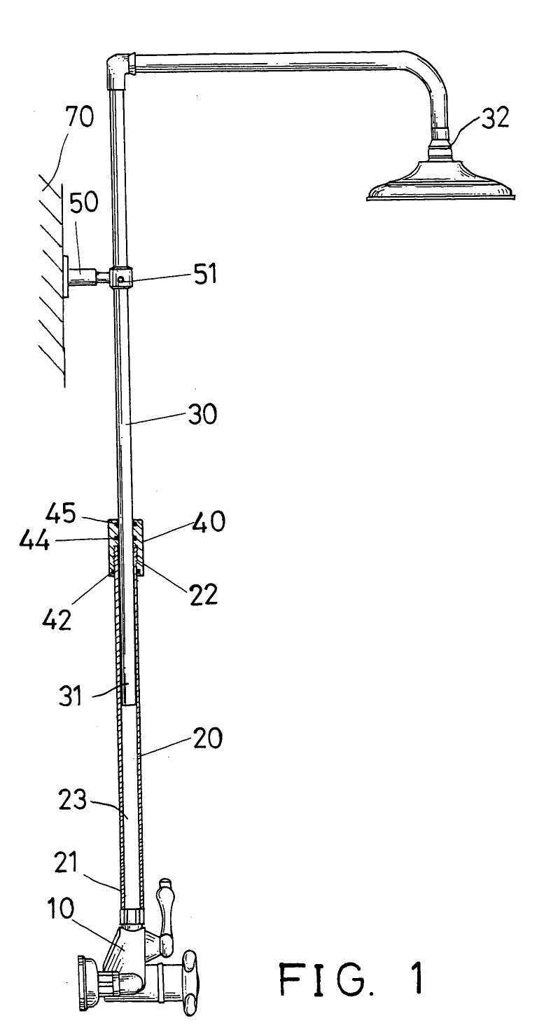

Referring to the drawings, and initially to FIG. 1, a shower device in accordance with the present invention comprises a conduit 20 including a lower portion 21 attached to a faucet or valve member 10, to receive water from a water supply source, and including an outer thread 22 formed or provided on the upper portion thereof, and including a bore 23 formed therein.

A tube 30 includes a lower portion 31 rotatably and slidably engaged into the bore 23 of the conduit 20, and easily and quickly slidable or adjustable up and down relative to the conduit 20, and includes a shower head 32 attached to top thereof, for directing toward and to shower the users. The shower head 32 may be attached or secured to top of the tube 30 with fasteners or the like, and to be moved up and down together with the tube 30.

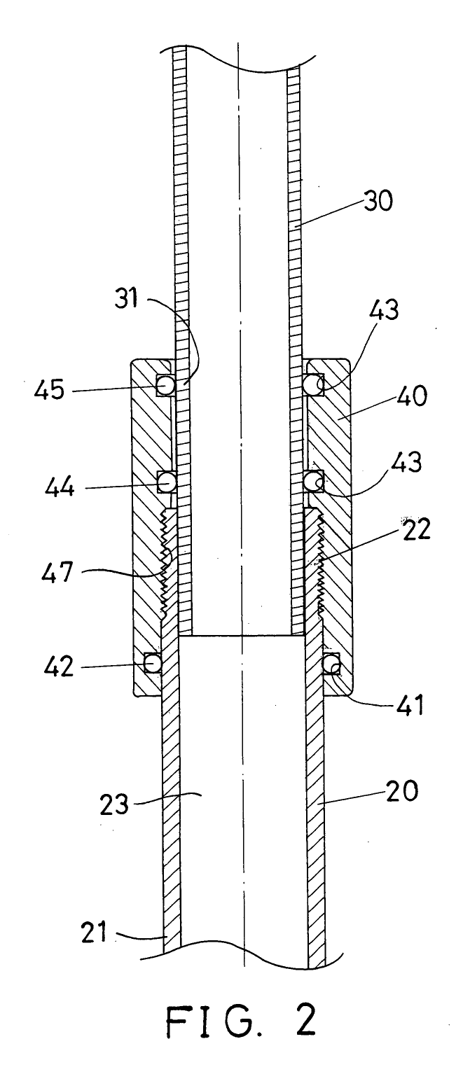

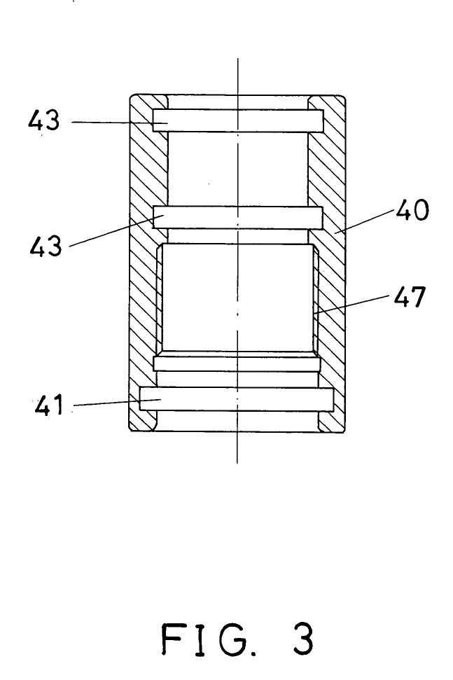

A control ferrule 40 is rotatably attached onto the conduit 20 and the tube 30, and disposed in the adjacent portion or the coupling portion of the conduit 20 and the tube 30. As shown in FIGS. 2 and 3, the control ferrule 40 includes one or more peripheral grooves 41 formed therein, such as formed in the lower portion thereof, for receiving sealing rings 42 therein, which may be engaged between the conduit 20 and the control ferrule 40, to make a water tight seal between the conduit 20 and the control ferrule 40.

The control ferrule 40 further includes one or more peripheral slots 43 formed therein for receiving sealing rings 44, 45 therein respectively, which may be engaged between the tube 30 and the control ferrule 40, to make a water tight seal between the tube 30 and the control ferrule 40.

The control ferrule 40 further includes an inner thread 47 formed therein, for threading with the outer thread 22 of the conduit 20, to secure the control ferrule 40 to the conduit 20, and to maintain the engagement of the sealing rings 42, 44, 45 with the conduit 20 and the tube 30 respectively. The tube 30 and thus the shower head 32 may be adjusted up and down relative to the conduit 20.

A bracket 50 may further be provided for attaching to the supporting walls or surfaces 70, and includes a ring 51 to support the tube 30, for example, and to secure the tube 30 to the supporting walls or surfaces 70.

In operation, as shown in FIG. 1, the tube 30 and thus the shower head 32 may be adjusted up and down relative to the conduit 20, and the control ferrule 40 may be secured to the conduit 20, and to maintain the engagement of the sealing rings 42, 44, 45 with the conduit 20 and the tube 30 respectively. The tube 30 and thus the shower head 32 may then be secured to the supporting walls or surfaces 70 with the bracket 50, for allowing the shower head 32 to be adjusted up and down relative to the supporting walls or surfaces 70 to different heights according to the heights of the users.

Accordingly, the shower device in accordance with the present invention includes an adjustable structure or configuration to allow the shower head to be easily adjusted up and down relative to the supporting walls or relative to the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A shower device comprising:
a conduit including a bore formed therein,
a tube including a lower portion slidably engaged into said bore of said conduit, to allow said tube to be adjusted up and down relative to said conduit,
a shower head attached to said tube and moved up and down together with said tube,
a control ferrule attached to said conduit and said tube, and including at least one first sealing ring engaged between said conduit and said control ferrule, to make a water tight seal between said conduit and said control ferrule, and including at least one second sealing ring engaged between said tube and said control ferrule, to make a water tight seal between said tube and said control ferrule, and
means for attaching said tube to a supporting surface.

2. The shower device as claimed in claim 1, wherein said conduit includes an outer thread formed thereon, said control ferrule includes an inner thread formed therein to thread with said outer thread of said conduit.

3. The shower device as claimed in claim 1, wherein said attaching means includes a bracket secured to the supporting surface, and having a ring to support said tube.
